(19) United States
(12) Patent Application Publication
(10) Pub. No.: US 2026/0155879 A1
(43) Pub. Date: Jun. 4, 2026

(54) UE INITIATED BEAM MEASUREMENT AND BEAM REPORTING

(71) Applicant: Lenovo (Beijing) Limited, Beijing (CN)

(72) Inventors: Bingchao Liu, Beijing (CN); Jianfeng Wang, Beijing (CN); Congchi Zhang, Shanghai (CN); Tingnan Bao, Beijing (CN); Xin Guo, Beijing (CN)

(73) Assignee: Lenovo (Beijing) Limited, Beijing (CN)

(21) Appl. No.: 18/874,750

(22) PCT Filed: Jun. 17, 2022
(86) PCT No.: PCT/CN2022/099479

§ 371 Date: Dec. 13, 2024

(51) Int. Cl. H04B 7/06; H04B 17/318; H04L 5/00

(52) U.S. Cl. CPC H04B 7/06952; H04B 17/328; H04L 5/0044

(57) ABSTRACT

Methods and apparatuses for beam management initiated by UE are disclosed. In one embodiment, a UE comprises a transceiver; and a processor coupled to the transceiver, wherein the processor is configured to transmit, via the transceiver, a beam management request message containing at least one beam management request, each beam management request is initiated for a cell for which a predicted beam invalidation event is detected; receive, via the transceiver, a response to the beam management request message; and perform beam management according to the response.

### FIELD

The subject matter disclosed herein generally relates to wireless communications, and more particularly relates to methods and apparatuses for UE initiated beam measurement and beam reporting.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), Machine learning (ML), artificial intelligence (AI), bandwidth part (BWP), block error rate (BLER), Reference Signal Receiving Power (RSRP), Layer 1 Reference Signal Receiving Power (L1-RSRP), medium access control (MAC), control element (CE), synchronization signal (SS), Physical Broadcast Channel (PBCH), SS/PBCH Block (SSB), Channel State Information (CSI), Channel State Information Reference Signal (CSI-RS), Physical Uplink Shared Channel (PUSCH), Physical Uplink Control Channel (PUCCH), scheduling request (SR), Downlink Control Information (DCI), Uplink Control Information (UCI), beam measurement (BM), Physical Downlink Control Channel (PDCCH), Hybrid Automatic Repeat request (HARQ), New Data Indicator (NDI), SSB resource indicator (SSBRI), CSI-RS resource indicator (CRI), Logical Channel ID (LCID).

Machine learning (ML) is a method to achieve artificial intelligence (AI). In the following description, they are described as AI/ML. AI/ML based beam prediction is studied in NR Release 18 for reduction of overhead and/or signaling. One potential use case is that a AI/ML function is deployed in a UE, and the UE can predict a beam in beam set A based on the measurement of beams in beam set B, where beam set A comprises of larger number of beams while beam set B comprises of small number of beams. However, since the prediction function is based on an AI model trained by a dataset, the predicted results may be mismatched with expected results. Considering the scenario that AI/ML function is deployed at the UE side, the UE can detect the event that predicted beam is not applicable or the prediction function is failed.

Traditionally, a beam management procedure is initiated (or triggered) by the base unit (e.g. gNB). Upon receiving the trigger of a beam management procedure for a set of beams, the UE performs measurement on the set of beams (i.e. beam measurement), and report a measurement result to the gNB (i.e. beam reporting). Incidentally, beam management may refer to beam measurement and beam reporting.

Since the UE can detect inapplicable predicted beam(s), the UE may be necessary to initiate a beam management procedure (e.g. beam measurement and report reporting procedure) for beam switching.

This invention targets beam management initiated by UE.

### BRIEF SUMMARY

Methods and apparatuses for beam management initiated by UE are disclosed.

In one embodiment, a UE comprises a transceiver; and a processor coupled to the transceiver, wherein the processor is configured to transmit, via the transceiver, a beam management request message containing at least one beam management request, each beam management request is initiated for a cell for which a predicted beam invalidation event is detected; receive, via the transceiver, a response to the beam management request message; and perform beam management according to the response.

In some embodiment, the processor is further configured to receive, via the transceiver, parameters for detecting the predicted beam invalidation event for each cell. The parameters for detecting the predicted beam invalidation event for a cell may include a quality threshold, and a max counter N where N is an integer that is 1 or more. The predicted beam invalidation event is detected for a cell if the predicted beam quality of the cell is worse than the quality threshold for N times.

In some embodiment, the beam management request message is a MAC CE with a dedicated LCID. Alternatively, the beam management request message is contained in a beam report.

In some embodiment, the beam management request message contains, for each cell for which the predicted beam invalidation event is detected, a beam set ID, or a beam ID and an RSRP, where beam set ID indicates a recommended beam set, the beam ID indicates a recommended beam contained in a recommended beam set, and the RSRP indicates L1-RSRP of the recommended beam.

In some embodiment, the response is a trigger of an aperiodic beam management procedure for each cell for which the beam management request is initiated.

In some other embodiment, if the response is a PDCCH scheduling a new PUSCH transmission that has the same HARQ process number as for the transmission of a PUSCH carrying a MAC CE which is the beam management request message or a UCI containing the beam management request message and that has a toggled NDI field value, the processor is configured to perform beam measurement for each cell for which the beam management request is initiated according to a recommended beam set for the cell indicated in the beam management request message, and transmit, via the transceiver, on the scheduled new PUSCH transmission, a beam measurement result for each cell.

In some further embodiment, if the response is a PDCCH scheduling a new PUCCH transmission that has the same PUCCH resource ID as the transmission of a PUCCH carrying a UCI containing the beam management request message and that is received within a time window, the processor is configured to perform beam measurement for each cell for which the beam management request is initiated according to a recommended beam set for the cell indicated in the beam management request message, and transmit, via the transceiver, on the scheduled new PUCCH transmission, a beam measurement result for each cell.

In another embodiment, a method performed at a UE comprises transmitting a beam management request message containing at least one beam management request, each beam management request is initiated for a cell for which a predicted beam invalidation event is detected; receiving a response to the beam management request message; and performing beam management according to the response.

In still another embodiment, a base unit comprises a transceiver; and a processor coupled to the transceiver, wherein the processor is configured to receive, via the transceiver, a beam management request message containing at least one beam management request, each beam management request is initiated for a cell for which a predicted beam invalidation event is detected; and transmit, via the transceiver, a response to the beam management request message.

In some embodiment, the processor is further configured to transmit, via the parameters for the predicted beam invalidation event for a cell may include a quality threshold, and a max counter N where N is an integer that is 1 or more.

In some embodiment, the beam management request message is a MAC CE with a dedicated LCID. Alternatively, the beam management request message is contained in a beam report.

In some embodiment, the beam management request message contains, for each cell for which the predicted beam invalidation event is detected, a beam set ID, or a beam ID and an RSRP, where beam set ID indicates a recommended beam set, the beam ID indicates a recommended beam contained in a recommended beam set, and the RSRP indicates L1-RSRP of the recommended beam.

In some embodiment, the response is a trigger of an aperiodic beam management for each cell for which the beam management request is initiated.

In some other embodiment, the response is a PDCCH scheduling a new PUSCH transmission that has the same HARQ process number as for the transmission of a PUSCH carrying a MAC CE which is the beam management request message or a UCI containing the beam management request message and that has a toggled NDI field value.

In some further embodiment, the response is a PDCCH scheduling a new PUCCH transmission that has the same PUCCH resource ID as the transmission of a PUCCH carrying a UCI containing the beam management request message and that is transmitted within a time window.

In yet another embodiment, a method performed at a base unit comprises receiving a beam management request message containing at least one beam management request, each beam management request is initiated for a cell for which a predicted beam invalidation event is detected; and transmitting a response to the beam management request message.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 illustrates a first format of a beam management request MAC CE;

FIG. 2 illustrates a second format of a beam management request MAC CE;

FIG. 3 illustrates triggering an aperiodic beam management procedure;

FIG. 4 illustrates confirming the beam management request;

FIG. 5 is a schematic flow chart diagram illustrating an embodiment of a method;

FIG. 6 is a schematic flow chart diagram illustrating an embodiment of another method; and

FIG. 7 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

In NR Release 17, beam management (e.g. beam measurement and the beam reporting) are performed according to network configuration. That is, the beam management is initiated by the base unit (e.g. gNB). For example, periodic beam measurement and beam reporting shall be performed periodically by UE(s) according to the configured report period and offset(s) by the gNB. For another example, aperiodic beam measurement and beam reporting shall be performed when a triggering DCI is received by the UE.

This disclosure proposes UE initiated beam management (e.g. beam measurement and the beam reporting) procedure. That is, the beam management procedure is triggered or requested by the UE.

A first embodiment relates to UE's transmitting a beam management request message.

A predicted beam invalidation event is defined for each cell (or the active BWP of the cell).

When the predicted beam invalidation event for a cell is detected, the UE shall send a beam management (e.g. beam measurement and beam reporting) request for the cell.

A beam management request message may include one or multiple (e.g. up to 8 when 8 serving cells are configured for a UE for multi-carrier operation) beam management requests, where each beam management request is for one cell for which the predicted beam invalidation event is detected.

The predicted beam invalidation event for a cell can be defined as: when the quality of the predicted beam for the cell is worse than a quality threshold (for the cell) for continuous N times (for the cell), the predicted beam invalidation event for the cell is detected, where the quality threshold and the max count of N for each cell can be indicated by the gNB in a RRC signaling.

The quality threshold can be for example an L1-RSRP threshold or a block error rate (BLER) threshold for the UE to assess whether the predicted beam (e.g. the predicted beam by the AI/ML function) is failed or not. For example, if the L1-RSRP of the predicted beam is lower than the L1-RSRP threshold (which means that the quality of the predicted beam is worse than the quality threshold), or if the BLER of the predicted beam is higher than the BLER threshold (which means that the quality of the predicted beam is worse than the quality threshold), an instance of failure of the predicted beam is determined.

A counter for counting the number of instances of the failure of the predicted beam is configured and initially set to 0 for each cell. If one instance of failure of the predicted beam for a cell is reported by lower layer, the counter for the cell is incremented by 1. If the counter for the cell reaches the configured max count (N) (e.g. N is an integer that is 1 or more) for the cell, the predicted beam invalidation event is detected for the cell.

In addition to the counter and the max count, a timer (e.g. 2 ms) may also be configured for each cell. Each time an instance of failure of the predicted beam for a cell is reported by lower layer, the timer for the cell starts or resets in addition that the counter for the cell is incremented by 1. If another instance of failure of the predicted beam for the cell is reported by lower layer before the timer expires, the timer for the cell resets in addition that the counter for the cell is incremented by 1, until the counter for the cell reaches the max count (N) for the cell. On the other hand, if after the timer expires, no additional instance of failure of the predicted beam for the cell is reported by lower layer, then, the counter for the cell is reset to 0.

A UE can be served by multiple cells in carrier aggregation mode, where each carrier corresponds to a cell. Multiple carriers with different frequency bands are configured for a UE to provide larger band for UL or DL transmission. The predicted beam invalidation event may be detected for any of the multiple cells. For example, an AI/ML function for beam prediction is configured for each cell.

A beam management request shall be initiated for a cell if the predicted beam invalidation event is detected for the cell.

A beam management request can be contained in a beam management request message. The beam management request message can be a MAC CE (e.g. beam management request MAC CE), or be contained in a beam report (e.g. revised CSI report).

(1) The beam management request message is a MAC CE (e.g. beam management request MAC CE), which has a dedicated LCID.

The beam management request MAC CE may contain one or multiple beam management requests (e.g. up to 8 beam management requests when 8 carriers are configured for the UE), where each beam management request is for one cell for which the predicted beam invalidation event is detected.

It means that if the predicted beam invalidation event is detected for multiple cells (e.g. up to 8 cells), the beam management requests for the multiple cells can be contained in one beam management request MAC CE.

Two different MAC CE formats are proposed for the beam management request MAC CE.

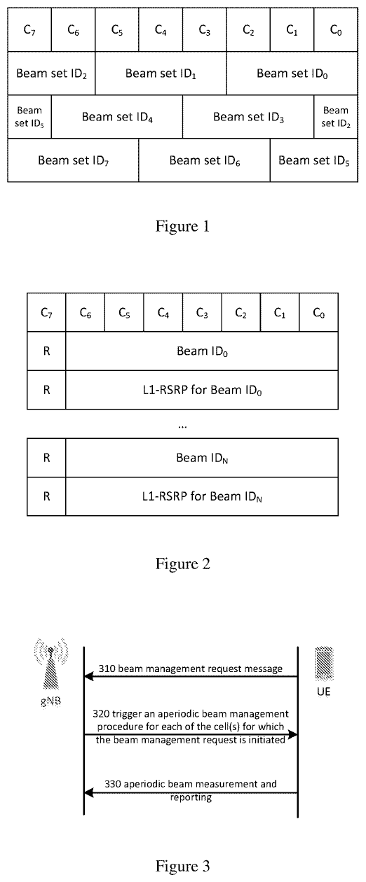

A first format of the beam management request MAC CE is illustrated in FIG. 1. Multiple beam sets (e.g. 8 beam sets) are configured and specified for each cell. Each beam set is identified by a beam set ID (e.g. with 3 bits when up to 8 beam sets are configured). Each beam set consists of one or more SSB resources or one or more periodic CSI-RS resources for beam measurement.

The first format of the beam management request MAC CE includes the following fields:

Cᵢ (i=0 to 7): a bitmap (i.e. 8 bits when 8 carriers are configured for the UE) of Cᵢ fields are contained in the first format of the beam management request MAC CE. Each Cᵢ field indicates a cell (or the active BWP of the cell). If the predicted beam invalidation event is detected for the active BWP of a cell identified by Cᵢ, the Cᵢ field is set to ‘1’, while if the predicted beam invalidation event is not detected for a cell identified by Cᵢ, the Cᵢ field is set to ‘0’. Each Cᵢ field being set to ‘1’ indicates that beam management for the cell indicated by Cᵢ field is requested.

Beam set IDᵢ (i=0 to 7): Each beam set IDᵢ field, if valid, indicates a recommended beam set for the cell indicated by Cᵢ. Only when the Cᵢ field is set to ‘1’, the beam set IDᵢ field is valid and indicates the recommended beam set for the cell identified by Cᵢ. If the Cᵢ field is set to ‘0’, the beam set ID; field is reserved.

A second format of the beam management request MAC CE is illustrated in FIG. 2. Multiple beam sets are configured and specified. Each beam set consists of one or more beams (e.g. up to 128 beams).

The second format of the beam management request MAC CE includes the following fields:

Cᵢ (i=0 to 7): a bitmap (i.e. 8 bits) of Cᵢ fields are contained in the first format of the beam management request MAC CE. Each Cᵢ field indicates a cell (or the active BWP of the cell). If the predicted beam invalidation event is detected for the active BWP of a cell identified by Cᵢ, the Cᵢ field is set to ‘1’, while if the predicted beam invalidation event is not detected for a cell identified by Cᵢ, the Cᵢ field is set to ‘0’. Each Cᵢ field being set to ‘1’ indicates that beam measurement for the cell indicated by Cᵢ field is requested.

Beam ID_{N} (N=0 to the number of Cᵢ field(s) being set to ‘1’ minus 1): the Beam ID_{N} field indicates a recommended beam for the cell indicated by the (N+1)^{th} Cᵢ field set to ‘1’. For example, if C₀ field, C₂ field and C₅ field are set to ‘1’ (while other Cᵢ fields are set to ‘0’), C₀ field is the first Cᵢ field set to ‘1’; C₂ field is the second Cᵢ field set to ‘1’; and C₅ field the third Cᵢ field set to ‘1’. Accordingly, there are three Beam ID_{N} fields, i.e. Beam ID₀, Beam ID₁, and Beam ID₂. Beam ID₀ indicates a recommended beam for the cell indicated by the first Cᵢ field set to ‘1’ (i.e. C₀ field); Beam ID₁ indicates a recommended beam for the cell indicated by the second Cᵢ field set to ‘1’ (i.e. C₂ field); and Beam ID₂ indicates a recommended beam for the cell indicated by the third Cᵢ field set to ‘1’ (i.e. C₅ field). The beam set containing the recommended beam indicated by the Beam ID_{N} field is the recommended beam set for the cell indicated by the (N+1)^{th} Cᵢ field set to ‘1’.

L1-RSRP for Beam ID_{N} (N=0 to the number of C; field(s) being set to ‘1’ minus 1): the L1-RSRP for Beam ID_{N} filed indicates the L1-RSRP for Beam ID_{N}.

In summary, the beam management request MAC CE (both the first format and the second format) can report beam management request(s) for up to 8 cells for each of which the predicted beam invalidation event is detected. It means that the beam management requests for up to 8 cells can be simultaneously contained in one beam management request MAC CE.

In addition to indicating the cell(s) for each of which the beam management request is initiated, the beam management request MAC CE (both the first format and the second format) also contains the information of the recommended beam set. That is, in the first format of beam management request MAC CE, the beam set ID; field indicates the recommended beam set; while in the second format of beam management request MAC CE, the Beam ID_{N} field indicates a recommended beam included in the recommended beam set. In addition, the second format of beam management request MAC CE also includes the L1-RSRP of the recommended beam.

As a whole, when predicted beam invalidation event is detected for at least one cell (i.e. at least one Cᵢ field of the beam management request MAC CE is set to ‘1’), the beam management request MAC CE may be triggered to be sent.

A dedicated PUCCH-SR resource can be configured for the UE. The UE uses the dedicated PUCCH-SR resource to send a request for a PUSCH transmission for the beam management request MAC CE. Upon receiving a DCI scheduling the PUSCH transmission for the beam management request MAC CE, the UE transmits the scheduled PUSCH transmission carrying the beam management request MAC CE.

(2) The beam management request message is contained in a beam report (e.g. revised CSI report carrying beam measurement results) transmitted as uplink control information (UCI).

When the UE is configured to perform beam management (beam measurement and beam reporting) periodically or triggered by an DCI containing a non-zero CSI request field to trigger an aperiodic beam measurement and report, the UE shall measure the beams indicated in the beam set configured by the gNB, and report a measurement result by a CSI report. The CSI report is transmitted as UCI.

This disclosure proposes to revise the CSI report to contain the beam management request message.

The beam management request message contained in a revised CSI report can only include the beam management request for one cell (i.e. the cell for which the beam report is sent).

Multiple beam sets (e.g. 8 beam sets) are configured and specified. Each beam set consists of one or more beams (e.g. 128 beams). Each beam is an SSB resource or a periodic CSI-RS resource for beam measurement.

Table 1 illustrates an example of the revised CSI report.

TABLE 1

| CSI | | |
|---|---|---|
| report | | |
| number | CSI fields | Number of bits |
| CSI | CRI or SSBRI #1 | ┌log₂(Kₛ^{CSI-RS})┐ or ┌log₂(Kₛ^{SSB})┐ |
| report#n | CRI or SSBRI #2 | ┌log₂(Kₛ^{CSI-RS})┐ or ┌log₂(Kₛ^{SSB})┐ |
| | CRI or SSBRI #3 | ┌log₂(Kₛ^{CSI-RS})┐ or ┌log₂(Kₛ^{SSB})┐ |
| | CRI or SSBRI #4 | ┌log₂(Kₛ^{CSI-RS})┐ or ┌log₂(Kₛ^{SSB})┐ |
| | RSRP #1 | 7 |
| | Differential RSRP #2 | 4 |
| | Differential RSRP #3 | 4 |
| | Differential RSRP #4 | 4 |
| | Whether BM is | 1 |
| | requested | |
| | Beam set ID or | ┌log₂(B_{group})┐ for beam set ID or |
| | Beam ID | ┌log₂(Kₚ^{CSI-RS})┐ or ┌log₂(Kₚ^{SSB})┐ for |
| | | beam ID |
| | RSRP | 7 |

The fields “Whether BM (beam management) is requested”, “Beam set ID or Beam ID” and “RSRP” are added for beam management request initiated by UE, while the other fields are legacy fields in a legacy CSI report as specified in 3GPP TS38.212 V16.5.0. In other words, the fields “Whether BM (beam management) is requested”, “Beam set ID or Beam ID” and “RSRP” correspond to the beam management request message. The “Beam set ID or Beam ID” and “RSRP” can be contained only when the “Whether BM is requested” field is set as ‘1’. In particular, when the “Whether BM is requested” field is set as ‘1’, the “Beam set ID” field, which indicates the recommended beam set, is further included; or the “Beam ID” field, which indicates a recommended beam included in a recommended beam set, and the “RSRP” field, which indicates the L1-RSRP of the recommended beam indicated by the “Beam ID” field, are further included.

In the added “Beam set ID or Beam ID” and “RSRP” fields, B_{group} refers to the number of configured beam sets;

$${K}_{p}^{CSI - RS}$$

is the number of an periodic CSI-RS resources used for beam measurement (if a beam is represented by a CSI-RS resource);

$${K}_{p}^{SSB}$$

is the number of all SSB resources (if a beam is represented by a SSB resource).

As a whole, when predicted beam invalidation event for a cell is detected, a revised CSI report containing a beam management request message including the beam management request for the cell is transmitted as UCI.

A second embodiment relates to the network behavior as well as subsequent UE behavior after the network (e.g. gNB) receives the beam management request message.

The beam management request message includes the beam management request for at least one cell (if the beam management request message is the beam management request MAC CE) and in particular for one cell (if the beam management request message is contained in a revised CSI report).

After receiving the beam management request for at least one cell from the UE, the gNB may send a response to the beam management request.

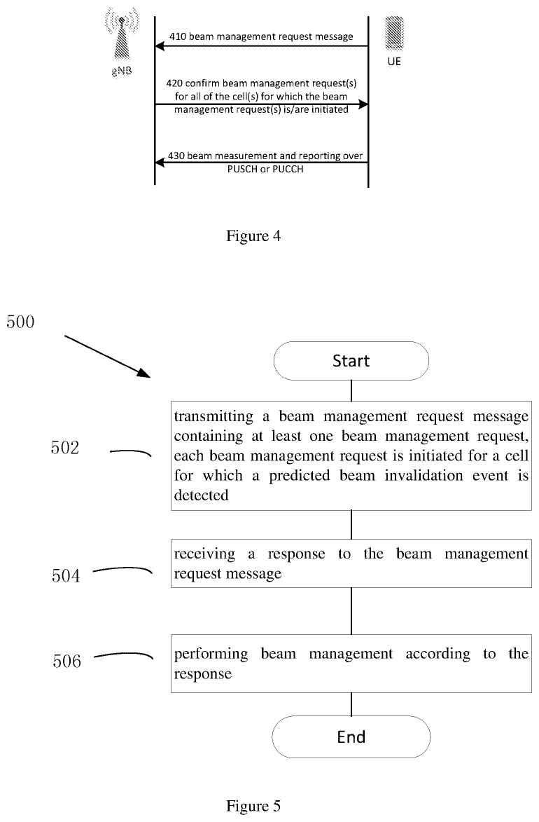

The response to the beam management request may be triggering an aperiodic beam management procedure for each of the cell(s) for which the beam management request is initiated (see FIG. 3), or confirming the beam management request(s) for all of the cell(s) for which the beam management request(s) is/are initiated (see FIG. 4).

FIG. 3 illustrates triggering an aperiodic beam management procedure.

In step 310, the gNB receives the beam management request message. For example, the beam management request message is the beam management request MAC CE including the beam management request(s) for at least one cell. For another example, the beam management request message is contained in the revised CSI report and includes the beam management request for one cell (i.e. the cell for which the revised CSI report is transmitted).

In step 320, the gNB triggers an aperiodic beam management procedure for each of the cell(s) for which the beam management request is initiated. For each aperiodic beam management procedure for one cell for which the beam management request is initiated, a set of beams are configured to be measured and reported. The set of configured beams for each aperiodic beam management procedure for a cell may be the same as or different from (e.g. according to network deployment) the recommended beam set for the cell indicated in the beam management request message.

Preferably, if, in step 310, the second format of the beam management request MAC CE is received or the revised CSI report includes the “beam ID” field and the “RSRP” field, step 320 is performed. With the L1-RSRP indicated by the “RSRP” field of the recommended beam indicated by the “beam ID” field, it is easy for the gNB to configure the set of beams for the cell to measure, if the configured set of beams is different from the recommended beam set for the cell.

Incidentally, for each cell for which the aperiodic beam management procedure is triggered, there shall be at least one aperiodic CSI report configuration for beam report in the active BWP of the cell.

In step 330, the UE performs beam measurement and beam reporting for each cell for which the aperiodic beam management procedure is initiated, according to the trigger in step 320. The detailed implementation of the beam measurement and beam reporting in step 330 is the same as legacy beam measurement and beam reporting, e.g. that specified in NR Release 15.

FIG. 4 illustrates confirming the beam management request.

In step 410, the gNB receives the beam management request message. Step 410 is the same as step 310.

In step 420, the gNB confirms the beam management request message. It means that the beam management request(s) for all of the cell(s) for which the beam management request(s) is/are initiated are confirmed.

The confirmation (or acknowledgement) of the beam management request message can be made as follows:

If the beam management request message is sent by the beam management request MAC CE carried in a PUSCH or by a UCI (revised CSI report) carried by a PUSCH, the UE may assume that the gNB confirms the UE's beam management request message when the UE receives a PDCCH with a DCI format scheduling a new PUSCH transmission that has the same HARQ process number as for the transmission of the PUSCH carrying the MAC CE or the UCI and has a toggled NDI field value.

If the beam management request message is sent by a UCI (revised CSI report) carried by a PUCCH, the UE may assume that the gNB confirms the UE's beam management request message when the UE receives a PDCCH with a DCI format scheduling a new PUCCH transmission that has the same PUCCH resource ID as the transmission of the PUCCH carrying the UCI within a time window, where the time window begins from the last symbol of the PUCCH transmission carrying the UCI. The length of the time window can be predefined or configured.

In step 430, in response to the gNB's confirmation (or acknowledgement), the UE shall perform beam measurement and beam reporting, for each cell for which the beam management request is initiated in the beam management request message. The set of beams to be measured and reported are the beams within the recommended beam set for each cell contained in the beam management request message in step 410. The measurement result(s) are transmitted by the new PUSCH or PUCCH transmission scheduled by the PDCCH received in step 420.

The detailed implementation of the beam measurement and reporting in step 430 is the same as legacy beam measurement and reporting, e.g. that specified in NR Release 15. For each cell for which the beam management procedure is confirmed, there shall be at least one CSI Report configuration for beam report in the active BWP of the cell.

FIG. 5 is a schematic flow chart diagram illustrating an embodiment of a method 500 according to the present application. In some embodiments, the method 500 is performed by an apparatus, such as a remote unit (e.g. UE). In certain embodiments, the method 500 may be performed by a processor executing program code, for example, a microcontroller, a microprocessor, a CPU, a GPU, an auxiliary processing unit, a FPGA, or the like.

The method 500 is a method performed at a UE, comprising: 502 transmitting a beam management request message containing at least one beam management request, each beam management request is initiated for a cell for which a predicted beam invalidation event is detected; 504 receiving a response to the beam management request message; and 506 performing beam management according to the response.

In some embodiment, the method further comprises receiving parameters for detecting the predicted beam invalidation event for each cell. The parameters for detecting the predicted beam invalidation event for a cell may include a quality threshold, and a max counter N where N is an integer that is 1 or more. The predicted beam invalidation event is detected for a cell if the predicted beam quality of the cell is worse than the quality threshold for N times.

In some embodiment, the beam management request message is a MAC CE with a dedicated LCID. Alternatively, the beam management request message is contained in a beam report.

In some embodiment, the beam management request message contains, for each cell for which the predicted beam invalidation event is detected, a beam set ID, or a beam ID and an RSRP, where beam set ID indicates a recommended beam set, the beam ID indicates a recommended beam contained in a recommended beam set, and the RSRP indicates L1-RSRP of the recommended beam.

In some embodiment, the response is a trigger of an aperiodic beam management procedure for each cell for which the beam management request is initiated.

In some other embodiment, if the response is a PDCCH scheduling a new PUSCH transmission that has the same HARQ process number as for the transmission of a PUSCH carrying a MAC CE which is the beam management request message or a UCI containing the beam management request message and that has a toggled NDI field value, the method comprises: performing beam measurement for each cell for which the beam management request is initiated according to a recommended beam set for the cell indicated in the beam management request message, and transmitting, on the scheduled new PUSCH transmission, a beam measurement result for each cell.

In some further embodiment, if the response is a PDCCH scheduling a new PUCCH transmission that has the same PUCCH resource ID as the transmission of a PUCCH carrying a UCI containing the beam management request message and that is received within a time window, the method comprises performing beam measurement for each cell for which the beam management request is initiated according to a recommended beam set for the cell indicated in the beam management request message, and transmitting, on the scheduled new PUCCH transmission, a beam measurement result for each cell.

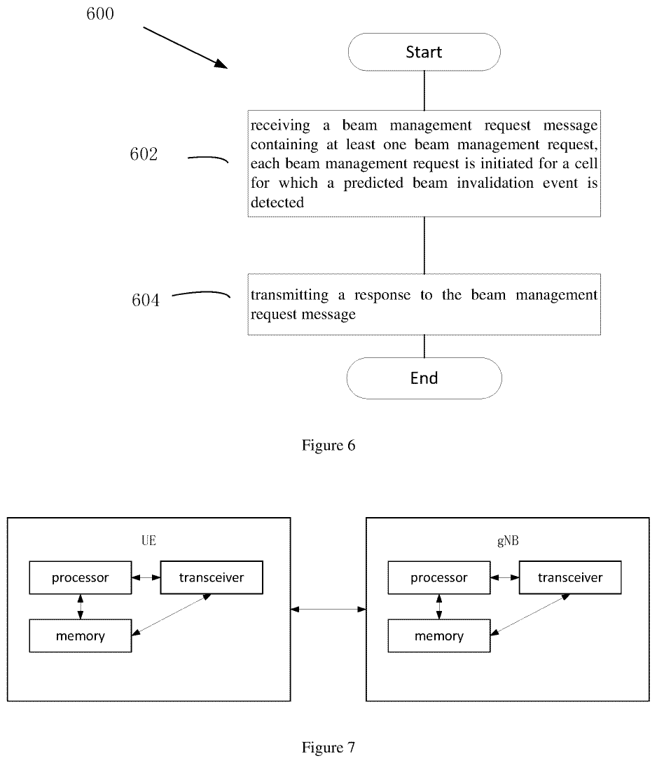

FIG. 6 is a schematic flow chart diagram illustrating an embodiment of a method 600 according to the present application. In some embodiments, the method 600 is performed by an apparatus, such as a base unit. In certain embodiments, the method 600 may be performed by a processor executing program code, for example, a microcontroller, a microprocessor, a CPU, a GPU, an auxiliary processing unit, a FPGA, or the like.

The method 600 may comprise 602 receiving a beam management request message containing at least one beam management request, each beam management request is initiated for a cell for which a predicted beam invalidation event is detected; and 604 transmitting a response to the beam management request message.

In some embodiment, the method further comprises transmitting parameters for detecting the predicted beam invalidation event for each cell. The parameters for the predicted beam invalidation event for a cell may include a quality threshold, and a max counter N where N is an integer that is 1 or more.

In some embodiment, the beam management request message is a MAC CE with a dedicated LCID. Alternatively, the beam management request message is contained in a beam report.

In some embodiment, the beam management request message contains, for each cell for which the predicted beam invalidation event is detected, a beam set ID, or a beam ID and an RSRP, where beam set ID indicates a recommended beam set, the beam ID indicates a recommended beam contained in a recommended beam set, and the RSRP indicates L1-RSRP of the recommended beam.

In some embodiment, the response is a trigger of an aperiodic beam management for each cell for which the beam management request is initiated.

In some other embodiment, the response is a PDCCH scheduling a new PUSCH transmission that has the same HARQ process number as for the transmission of a PUSCH carrying a MAC CE which is the beam management request message or a UCI containing the beam management request message and that has a toggled NDI field value.

In some further embodiment, the response is a PDCCH scheduling a new PUCCH transmission that has the same PUCCH resource ID as the transmission of a PUCCH carrying a UCI containing the beam management request message and that is transmitted within a time window.

FIG. 7 is a schematic block diagram illustrating apparatuses according to one embodiment.

Referring to FIG. 7, the UE (i.e. the remote unit) includes a processor, a memory, and a transceiver. The processor implements a function, a process, and/or a method which are proposed in FIG. 5.

The UE comprises a transceiver; and a processor coupled to the transceiver, wherein the processor is configured to transmit, via the transceiver, a beam management request message containing at least one beam management request, each beam management request is initiated for a cell for which a predicted beam invalidation event is detected; receive, via the transceiver, a response to the beam management request message; and perform beam management according to the response.

In some embodiment, the processor is further configured to receive, via the parameters for detecting the predicted beam invalidation event for a cell may include a quality threshold, and a max counter N where N is an integer that is 1 or more. The predicted beam invalidation event is detected for a cell if the predicted beam quality of the cell is worse than the quality threshold for N times.

In some embodiment, the beam management request message is a MAC CE with a dedicated LCID. Alternatively, the beam management request message is contained in a beam report.

In some embodiment, the beam management request message contains, for each cell for which the predicted beam invalidation event is detected, a beam set ID, or a beam ID and an RSRP, where beam set ID indicates a recommended beam set, the beam ID indicates a recommended beam contained in a recommended beam set, and the RSRP indicates L1-RSRP of the recommended beam.

In some embodiment, the response is a trigger of an aperiodic beam management procedure for each cell for which the beam management request is initiated.

In some other embodiment, if the response is a PDCCH scheduling a new PUSCH transmission that has the same HARQ process number as for the transmission of a PUSCH carrying a MAC CE which is the beam management request message or a UCI containing the beam management request message and that has a toggled NDI field value, the processor is configured to perform beam measurement for each cell for which the beam management request is initiated according to a recommended beam set for the cell indicated in the beam management request message, and transmit, via the transceiver, on the scheduled new PUSCH transmission, a beam measurement result for each cell.

In some further embodiment, if the response is a PDCCH scheduling a new PUCCH transmission that has the same PUCCH resource ID as the transmission of a PUCCH carrying a UCI containing the beam management request message and that is received within a time window, the processor is configured to perform beam measurement for each cell for which the beam management request is initiated according to a recommended beam set for the cell indicated in the beam management request message, and transmit, via the transceiver, on the scheduled new PUCCH transmission, a beam measurement result for each cell.

The gNB (i.e. the base unit) includes a processor, a memory, and a transceiver. The processor implements a function, a process, and/or a method which are proposed in FIG. 6.

The base unit comprises a transceiver; and a processor coupled to the transceiver, wherein the processor is configured to receive, via the transceiver, a beam management request message containing at least one beam management request, each beam management request is initiated for a cell for which a predicted beam invalidation event is detected; and transmit, via the transceiver, a response to the beam management request message.

In some embodiment, the processor is further configured to transmit, via the transceiver, parameters for detecting the predicted beam invalidation event for each cell. The parameters for the predicted beam invalidation event for a cell may include a quality threshold, and a max counter N where N is an integer that is 1 or more.

In some embodiment, the beam management request message is a MAC CE with a dedicated LCID. Alternatively, the beam management request message is contained in a beam report.

In some embodiment, the beam management request message contains, for each cell for which the predicted beam invalidation event is detected, a beam set ID, or a beam ID and an RSRP, where beam set ID indicates a recommended beam set, the beam ID indicates a recommended beam contained in a recommended beam set, and the RSRP indicates L1-RSRP of the recommended beam.

In some embodiment, the response is a trigger of an aperiodic beam management for each cell for which the beam management request is initiated.

In some other embodiment, the response is a PDCCH scheduling a new PUSCH transmission that has the same HARQ process number as for the transmission of a PUSCH carrying a MAC CE which is the beam management request message or a UCI containing the beam management request message and that has a toggled NDI field value.

In some further embodiment, the response is a PDCCH scheduling a new PUCCH transmission that has the same PUCCH resource ID as the transmission of a PUCCH carrying a UCI containing the beam management request message and that is transmitted within a time window.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated in the appended claims rather than by the foregoing description. All changes which come within the meaning and range of equivalency of the claims are to be embraced within their scope.

1. A user equipment (UE) for wireless communication, comprising:
at least one memory; and
at least one processor coupled with the at least one memory and configured to cause the UE to:
transmit a beam management request message containing at least one beam management request, each beam management request is initiated for a cell for which a predicted beam invalidation event is detected;
receive a response to the beam management request message; and
perform beam management according to the response.

2. The UE of claim 1, wherein the at least one processor is configured to cause the UE to receive parameters for detecting the predicted beam invalidation event for each cell.

3. The UE of claim 2, wherein the parameters for detecting the predicted beam invalidation event for the cell includes a quality threshold, and a max counter integer that is one or more.

4. The UE of claim 3, wherein the predicted beam invalidation event is detected for the cell if a predicted beam quality of the cell is worse than the quality threshold for a number of times.

5. The UE of claim 1, wherein the beam management request message is a medium access control-control element (MAC CE) with a dedicated logical channel ID (LCID).

6. The UE of claim 1, wherein the beam management request message is contained in a beam report.

7. The UE of claim 1, wherein the beam management request message contains, for each cell for which the predicted beam invalidation event is detected, a beam set ID, or a beam ID and a reference signal receiving power (RSRP), where the beam set ID indicates a recommended beam set, the beam ID indicates a recommended beam contained in a recommended beam set, and the RSRP indicates L1-RSRP of the recommended beam.

8. The UE of claim 1, wherein the response is a trigger of an aperiodic beam management procedure for each cell for which the beam management request is initiated.

9. The UE of claim 1, wherein, if the response is a physical downlink control channel (PDCCH) scheduling a new physical uplink shared channel (PUSCH) transmission that has a same hybrid automatic repeat request (HARQ) process number as for a transmission of a PUSCH carrying a medium access control-control element (MAC CE) which is the beam management request message or an uplink control information (UCI) containing the beam management request message and that has a toggled new data indicator (NDI) field value, then the at least one processor is configured to cause the UE to:
perform beam measurement for each cell for which the beam management request is initiated according to a recommended beam set for the cell indicated in the beam management request message; and
transmit on the scheduled new PUSCH transmission, a beam measurement result for each cell.

10. The UE of claim 1, wherein, if the response is a physical downlink control channel (PDCCH) scheduling a new physical uplink control channel (PUCCH) transmission that has a same PUCCH resource ID as a transmission of a PUCCH carrying an uplink control information (UCI) containing the beam management request message and that is received within a time window, then the at least one processor is configured to cause the UE to:
perform beam measurement for each cell for which the beam management request is initiated according to a recommended beam set for the cell indicated in the beam management request message; and
transmit on the scheduled new PUCCH transmission, a beam measurement result for each cell.

11. A method performed by a user equipment (UE), the method comprising:
transmitting a beam management request message containing at least one beam management request, each beam management request is initiated for a cell for which a predicted beam invalidation event is detected;
receiving a response to the beam management request message; and
performing beam management according to the response.

12. A base unit for wireless communication, comprising:
at least one memory; and
at least one processor coupled with the at least one memory and configured to cause the base unit to:
receive a beam management request message containing at least one beam management request, each beam management request is initiated for a cell for which a predicted beam invalidation event is detected; and
transmit a response to the beam management request message.

13. The base unit of claim 12, wherein the at least one processor is configured to cause the base unit to transmit parameters for detecting the predicted beam invalidation event for each cell.

14. The base unit of claim 12, wherein the beam management request message is a medium access control-control element (MAC CE) with a dedicated logical channel ID (LCID), or is contained in a beam report.

15. The base unit of claim 12, wherein the beam management request message contains, for each cell for which the predicted beam invalidation event is detected, a beam set ID, or a beam ID and a reference signal receiving power (RSRP), where the beam set ID indicates a recommended beam set, the beam ID indicates a recommended beam contained in the recommended beam set, and the RSRP indicates L1-RSRP of the recommended beam.

16. A processor for wireless communication, comprising:
at least one controller coupled with at least one memory and configured to cause the processor to:
transmit a beam management request message containing at least one beam management request, each beam management request is initiated for a cell for which a predicted beam invalidation event is detected;
receive a response to the beam management request message; and
perform beam management according to the response.

17. The processor of claim 16, wherein the at least one controller is configured to cause the processor to receive parameters for detecting the predicted beam invalidation event for each cell.

18. The processor of claim 17, wherein the parameters for detecting the predicted beam invalidation event for the cell includes a quality threshold, and a max counter integer that is one or more.

19. The processor of claim 18, wherein the predicted beam invalidation event is detected for the cell if a predicted beam quality of the cell is worse than the quality threshold for a number of times.

20. The processor of claim 16, wherein the beam management request message is a medium access control-control element (MAC CE) with a dedicated logical channel ID (LCID).
